(19) United States
(12) Patent Application Publication
(10) Pub. No.: US 2025/0389375 A1
(43) Pub. Date: Dec. 25, 2025

(54) MOBILE PHONE HOLDER

(71) Applicant: Shenzhen Yuecheng Yuezhen Industrial Development Co., Ltd, Guangdong (CN)

(72) Inventor: Zhanyue LI, Guangdong (CN)

(21) Appl. No.: 18/922,315

(22) Filed: Oct. 21, 2024

(30) Foreign Application Priority Data
Jun. 20, 2024 (CN) 202421420218.8

(51) Int. Cl. F16M 13/00; F16B 47/00; F16M 13/02

(52) U.S. Cl. CPC F16M 13/005; F16B 47/00; F16M 13/022

(57) ABSTRACT

A mobile phone holder includes a support member, a rotating assembly and a suction pad, where a through hole is arranged on the support member; the rotating assembly includes a rotating disc and a base, the rotating disc is rotatably arranged on the base with the axis of the base as the rotation center, and one side of the base away from the rotating disc is configured to be bonded to a mobile phone; the support member is rotatably connected to the rotating disc, and the rotating assembly is capable of passing through the through hole; the suction pad is fixed on one side of the rotating disc away from the base.

### CROSS-REFERENCE TO RELATED APPLICATIONS

This application claims priority to Chinese Patent Application No. 202421420218.8 filed Jun. 20, 2024, the disclosure of which is incorporated herein by reference in its entirety.

### TECHNICAL FIELD

The present disclosure relates to the field of mobile phone accessories and, for example, to a mobile phone holder.

### BACKGROUND

With the increasingly rapid development of smartphones, a growing variety of mobile phone accessories are available, and mobile phone holders are one of the common mobile phone accessories. A mobile phone can be supported through a mobile phone holder at a certain angle relative to a platform to meet the usage requirement of the user.

The existing mobile phone holder includes a finger ring and an adhesive sticker. The adhesive sticker is used for bonding the mobile phone, and the finger ring is rotatably connected to the adhesive sticker. During usage, the mobile phone holder is bonded to the mobile phone, and when the mobile phone is placed on a horizontal surface, the placement angle of the mobile phone can be adjusted by rotating the finger ring. The existing mobile phone holder has a narrow range of use and poor versatility and can mostly only be used on a horizontal surface. When the mobile phone holder is used on a horizontal surface, the mobile phone holder can only support the mobile phone in a certain fixed manner and at a certain fixed angle, thereby failing to flexibly meet the requirements of a user for the placement of the mobile phone at different angles.

### SUMMARY

The present disclosure provides a mobile phone holder. The mobile phone holder has great versatility and can flexibly meet the requirements of a user for the placement of the mobile phone at different angles. In addition, the mobile phone holder can enable the mobile phone to be adsorbed on a smooth surface at any angle.

A mobile phone holder includes a support member, a rotating assembly and a suction pad.

The support member includes a through hole.

The rotating assembly includes a rotating disc and a base. The rotating disc is rotatably disposed on the base by taking the axis of the base as the rotation center. One side of the base away from the rotating disc is configured to be bonded to a mobile phone. The support member is rotatably connected to the rotating disc. The rotating assembly is capable of passing through the through hole.

The suction pad is fixed on one side of the rotating disc away from the base.

In some embodiments, when the rotating disc rotates with the axis of the base as the rotation center, the rotating disc is capable of self-locking at a rotation stop position.

In some embodiments, the rotating disc is rotatably sleeved outside the base. The inner sidewall of the rotating disc includes a wave structure. The rotating assembly further includes an elastic member and an abutment member. The base includes an accommodation recess. The elastic member and the abutment member are located in the accommodation recess. One end of the elastic member is connected to the bottom wall of the accommodation recess or abuts against the bottom wall of the accommodation recess, another end of the elastic member is connected to one end of the abutment member or abuts against one end of the abutment member, and another end of the abutment member abuts against the wave structure.

In some embodiments, the elastic member is a spring. The bottom wall of the accommodation recess is provided with a first guide portion, and one end of the elastic member is sleeved on the first guide portion and abuts against the bottom wall of the accommodation recess.

In some embodiments, one end of the abutment member includes a recess. A bottom wall of the recess is provided with a second guide portion. The another end of the elastic member is sleeved on the second guide portion and abuts against the bottom wall of the recess.

In some embodiments, the rotating assembly further includes an end cap. The rotating disc is rotatably sleeved outside the base, and the inner bottom wall of the rotating disc is provided with a rotating shaft. The rotating shaft passes through the base and is detachably connected to the end cap, and the end cap abuts against the base.

In some embodiments, the support member includes an opening. The rotating disc is provided with a connecting portion. The connecting portion is located at the opening. The rotating assembly further includes a positioning shaft. The positioning shaft is passed through the connecting portion and two ends of the positioning shaft are located in two ends of the support member, respectively, to connect the support member with the connecting portion.

In some embodiments, an adhesive sticker is on the one side of the base away from the rotating disc, and the adhesive sticker is used for bonding the mobile phone.

In some embodiments, an adhesive sticker is on the one side of the rotating disc away from the base, and the suction pad is bonded to the rotating disc through the adhesive sticker.

In some embodiments, the suction pad includes a base plate and a plurality of suction cups. The plurality of suction cups are arranged on the base plate at intervals.

### BRIEF DESCRIPTION OF DRAWINGS

FIG. 1 is a structure view of a mobile phone holder provided in the present disclosure;

FIG. 2 is an exploded view of the mobile phone holder provided in the present disclosure;

FIG. 3 is a structure view of a rotating disc involved in the present disclosure;

FIG. 4 is a structure view of a base involved in the present disclosure; and

FIG. 5 is a structure view of an abutment member involved in the present disclosure.

In the drawings:
1. support member; 11. through hole; 12. opening;
2. rotating assembly; 21. rotating disc; 211. rotating shaft; 212. connecting portion; 22. base; 221. accommodation recess; 222. first guide portion; 23. end cap; 24. elastic member; 25. abutment member; 251. recess; 252. second guide portion; 26. positioning shaft;
3. suction pad; 31. base plate; 32. suction cup.

### DETAILED DESCRIPTION

The present disclosure is further described below in detail in conjunction with drawings and embodiments. It is to be understood that the embodiments set forth below are intended to explain the present disclosure and not to limit the present disclosure. In addition, it is further to be noted that, for ease of description, only a part, not all, related to the present disclosure is illustrated in the drawings.

In the description of the present disclosure, unless otherwise expressly specified and limited, the term “connected to each other”, “connected” or “fixed” is to be construed in a broad sense, for example, as fixedly connected, detachably connected, or integrated; mechanically connected or electrically connected; directly connected to each other or indirectly connected to each other via an intermediary; or internally connected between two elements or an interactional relationship between two elements. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature and the second feature may be in direct contact or may be in contact via another feature between the two features instead of being in direct contact. Moreover, when the first feature is described as “on”, “above” or “over” the second feature, the first feature is right on, above or over the second feature, the first feature is obliquely on, above or over the second feature, or the first feature is simply at a higher level than the second feature. When the first feature is described as “under”, “below” or “underneath” the second feature, the first feature is right under, below or underneath the second feature, the first feature is obliquely under, below or underneath the second feature, or the first feature is simply at a lower level than the second feature.

In the description of the embodiments of the present disclosure, orientations or position relations indicated by terms such as “upper”, “lower” and “right” are based on orientations or position relations shown in the drawings. These orientations or position relations are intended only to facilitate description and simplify operations and not to indicate or imply that an apparatus or element referred to must have such specific orientations or must be configured or operated in such specific orientations. Thus, these orientations or position relations are not to be construed as limiting the present disclosure. In addition, the terms “first” and “second” are used only for distinguishing descriptively and have no special meanings.

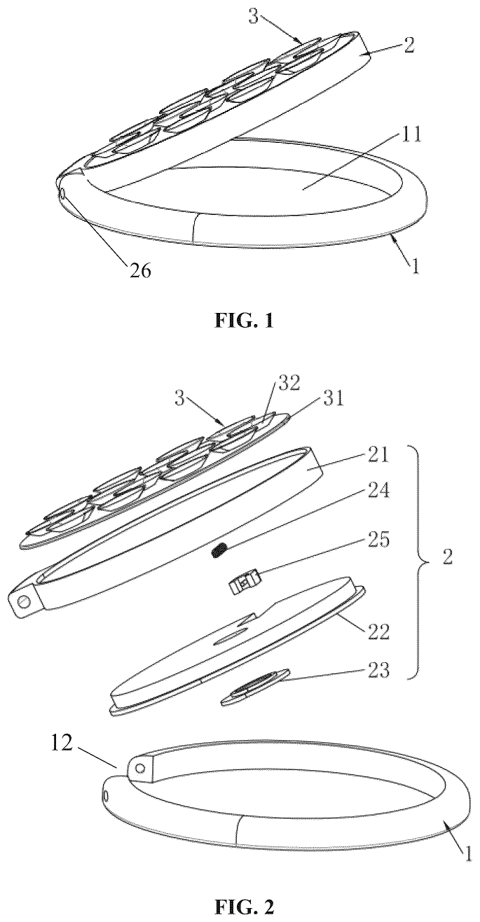

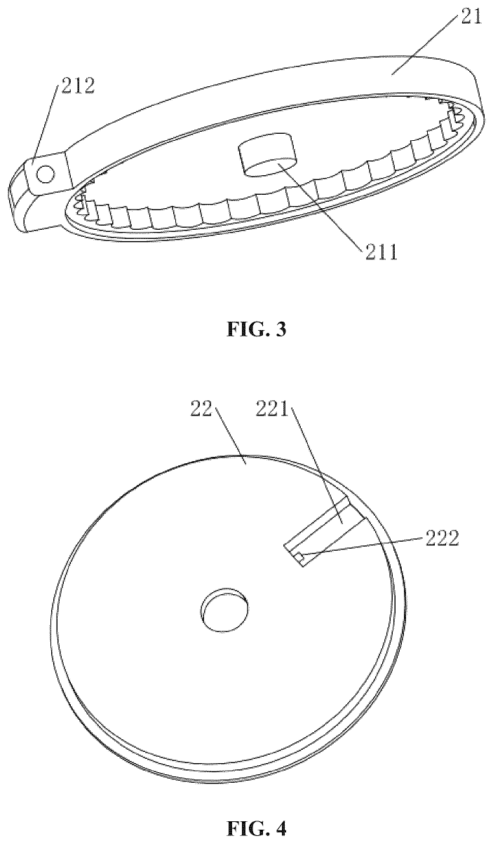

As shown in FIGS. 1 to 5, the present disclosure provides a mobile phone holder. The mobile phone holder includes a support member 1, a rotating disc 2 and a suction pad 3. A through hole 11 is arranged on the holder member 1. The rotating assembly 2 includes a rotating disc 21 and a base 22. The rotating disc 21 is rotatably connected to the base 22 with the axis of the base 22 as the rotation center. One side of the base 22 away from the rotating disc 21 is configured to be bonded to a mobile phone. The support member 1 is rotatably connected to the rotating disc 21. The rotating assembly 2 is capable of passing through the through hole 11. The suction pad 3 is fixed on one side of the rotating disc 21 away from the base 22. The mobile phone holder has great versatility and can be used on horizontal surfaces and smooth surfaces at any angle. During installation, the mobile phone is bonded to the base 22. When the mobile phone is placed on a horizontal surface, the angle at which the mobile phone is supported can be adjusted through the relative rotation between the support member 1 and the rotating disc 21 and the rotation of the support member 1 driven by the rotating disc 21 with the axis of the base 22 as the rotation center, thereby flexibly meeting the requirements of a user for the placement of the mobile phone at different angles.

The support member 1 and the rotating disc 21 are rotatably connected to each other, and the rotating assembly 2 can pass through the through hole 11, thereby allowing the support member 1 to rotate by 360 degrees relative to the rotating disc 21. The mobile phone can be absorbed onto a smooth surface at any angle through the suction pad 3. Specifically, as shown in FIG. 1, under the premise that the mobile phone is bonded to the base 22, the rotating assembly 2 is kept immobile, the support member 1 rotates clockwise so that the support member 1 is reversely sleeved outside the rotating assembly 2, and then the suction pad 3 is adsorbed onto a smooth surface. Alternatively, under the premise that the adsorption of the suction pad 3 is not affected, the angle between the support member 1 and the rotating assembly 2 may become 180 degrees, and then the suction pad 3 is adsorbed onto a smooth surface.

In some embodiments, when the rotating disc 21 rotates with the axis of the base 22 as the rotation center, the rotating disc 21 is capable of self-locking at a rotation stop position. In this manner, the support stability is guaranteed, and the rotation is performed smoothly. In some embodiments, as shown in FIGS. 2 to 4, the rotating disc 21 is rotatably sleeved outside the base 22. A wave structure is arranged on the inner sidewall of the rotating disc 21. The rotating assembly 2 further includes an elastic member 24 and an abutment member 25. The base 22 is provided with an accommodation recess 221. The elastic member 24 and the abutment member 25 are located in the accommodation recess 221. One end of the elastic member 24 is connected to the bottom wall of the accommodation recess 221 or abuts against the bottom wall of the accommodation recess 221, another end of the elastic member 24 is connected to one end of the abutment member 25 or abuts against one end of the abutment member 25, and another end of the abutment member 25 abuts against the wave structure. In this manner, when the abutment member 25 abuts against a trough of the wave structure, the rotating disc 21 can self-lock at a rotation stop position, thereby achieving a simple structure and convenient operations.

In other embodiments, a wave structure is arranged on the outer sidewall of the base 22, and an accommodation recess is concavely arranged on the inner sidewall of the rotating disc 21. One end of the elastic member 24 is connected to the bottom wall of the accommodation recess or abuts against the bottom wall of the accommodation recess, another end of the elastic member 24 is connected to one end of the abutment member 25 or abuts against one end of the abutment member 25, and another end of the abutment member 25 abuts against the wave structure. In this manner, the rotating disc 21 can also self-lock at a rotation stop position.

In some embodiments, in this embodiment, the elastic member 24 is a spring. A first guide portion 222 is arranged on the bottom wall of the accommodation recess 221, and one end of the elastic member 24 is sleeved on the first guide portion 222 and abuts against the bottom wall of the accommodation recess 221. When the elastic member 24 is set as a spring, a great elastic effect is achieved, and the cost is relatively low. The first guide portion 222 is set to act as a guide when elastic deformation occurs on the spring.

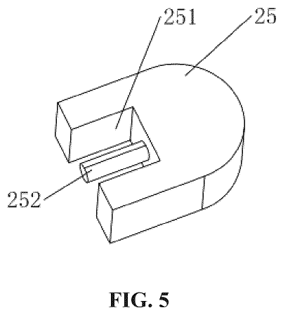

In some embodiments, in this embodiment, as shown in FIG. 5, a recess 251 is arranged on one end of the abutment member 25. A second guide portion 252 is arranged on the bottom wall of the recess 251. Another end of the elastic member 24 is sleeved on the second guide portion 252 and abuts against the bottom wall of the recess 251. The second guide portion 252 is set to act as a better guide when elastic deformation occurs on the spring. In some embodiments, a semi-circular abutment member portion is arranged on another end of the abutment member 25, and the semi-circular abutment portion abuts against the wave structure. In this manner, the manufacturing is simple, and the installation becomes easy. In other embodiments, the abutment member 25 is a ball. One end of the ball is fixedly connected to the elastic member 24, and another end of the ball abuts against the wave structure.

In some embodiments, the rotating assembly 2 further includes an end cap 23. The rotating disc 21 is rotatably sleeved outside the base 22, and a rotating shaft 211 is arranged on the inner bottom wall of the rotating disc 21. The rotating shaft 211 passes through the base 22 and is detachably connected to the end cap 23, and the end cap 23 abuts against the base 22. The detachable connection between the rotating shaft 211 and the end cap 23 facilitates assembly and disassembly. In some embodiments, the rotating shaft 211 is engaged with the end cap 23 or is threadably connected with the end cap 23. Optionally, in this embodiment, a bypass groove is arranged on the bottom of the base 22, and the end cap 23 is located in the bypass groove. In this manner, the end cap 23 is prevented from obstructing the mobile phone. Optionally, in this embodiment, the bypass groove is a stepped groove, and the end cap 23 is a stepped structure provided with an inner hole, to increase the contact area between the inner hole of the end cap 23 and the rotating shaft 211, thereby improving the connection strength. At the same time, the bypass groove is not set as a straight groove of the same diameter, thereby ensuring the strength of the base 22.

In some embodiments, the support member 1 includes an opening 12. The rotating disc 21 is provided with a connecting portion 212. The connecting portion 212 is located at the opening 12. The rotating assembly 2 further includes a positioning shaft 26. The positioning shaft 26 is arranged through the connecting portion 212 and two ends of the support member 1 to connect the support member 1 with the connecting portion 212. In this manner, the rotation becomes easy, and the structure is simple. Optionally, in this embodiment, the support member 1 is a ring, and the rotating disc 21 is a circular disc. In this manner, the structure is simple, and the manufacturing becomes easy.

In some embodiments, in this embodiment, an adhesive sticker is arranged on side of the base 22 away from the rotating disc 21, and the adhesive sticker is used for bonding the mobile phone. Optionally, in this embodiment, an adhesive sticker is arranged on one side of the rotating disc 21 away from the base 22, and the suction pad 3 is bonded to the rotating disc 21 through the adhesive sticker, thereby achieving the fixation between the suction pad 3 and the rotating disc 21. Optionally, in other embodiments, the suction pad 3 is engaged with the rotating disc 21 or is integrated with the rotating disc 21.

In some embodiments, the suction pad 3 includes a base plate 31 and a plurality of suction cups 32. The plurality of suction cups 32 are arranged on the base plate 31 at intervals. The plurality of suction cups 32 are arranged on the base plate 31 at equal intervals, thereby achieving uniform adsorption. In some embodiments, the base plate 31 is a circular structure, and at least two suction cups 32 among the plurality of suction cups 32 are set as a group. A plurality of groups of suction cups 32 are arranged at intervals in the radial direction of the base plate 31, and at least two suction cups 32 in each group are arranged at intervals in the circumferential direction of the base plate 31. In this manner, the structure is simple, and the manufacturing becomes easy.

Apparently, the preceding embodiments of the present disclosure are examples for clearly illustrating the present disclosure and are not intended to limit the implementations of the present disclosure. Those of ordinary skill in the art can make various apparent modifications, adaptations, and substitutions without departing from the scope of the present disclosure. All implementations cannot be and do not need to be exhausted herein. Any modifications, equivalent substitutions, and improvements made within the spirit and principle of the present disclosure fall within the scope of the claims of the present disclosure.

What is claimed is:

1. A mobile phone holder, comprising:
a support member, comprising a through hole;
a rotating assembly, comprising a rotating disc and a base, wherein the rotating disc is rotatably disposed on the base by taking an axis of the base as a rotation center, and one side of the base away from the rotating disc is configured to be bonded to a mobile phone; the support member is rotatably connected to the rotating disc, and the rotating assembly is capable of passing through the through hole; and
a suction pad, fixed on one side of the rotating disc away from the base.

2. The mobile phone holder according to claim 1, wherein when the rotating disc rotates with the axis of the base as the rotation center, the rotating disc is capable of self-locking at a rotation stop position.

3. The mobile phone holder according to claim 2, wherein the rotating disc is rotatably sleeved outside the base, an inner sidewall of the rotating disc comprises a wave structure; the rotating assembly further comprises an elastic member and an abutment member, the base comprises an accommodation recess, and the elastic member and the abutment member are located in the accommodation recess; one end of the elastic member is connected to a bottom wall of the accommodation recess or abuts against a bottom wall of the accommodation recess, another end of the elastic member is connected to one end of the abutment member or abuts against one end of the abutment member, and another end of the abutment member abuts against the wave structure.

4. The mobile phone holder according to claim 3, wherein the elastic member is a spring, the bottom wall of the accommodation recess is provided with a first guide portion, and the one end of the elastic member is sleeved on the first guide portion and abuts against the bottom wall of the accommodation recess.

5. The mobile phone holder according to claim 4, wherein the one end of the abutment member comprises a recess, a bottom wall of the recess is provided with a second guide portion, and the another end of the elastic member is sleeved on the second guide portion and abuts against the bottom wall of the recess.

6. The mobile phone holder according to claim 1, wherein the rotating assembly further comprises an end cap, the rotating disc is rotatably sleeved outside the base, an inner bottom wall of the rotating disc is provided with a rotating shaft, the rotating shaft passes through the base and is detachably connected to the end cap, and the end cap abuts against the base.

7. The mobile phone holder according to claim 1, wherein the support member comprises an opening, the rotating disc is provided with a connecting portion, and the connecting portion is located at the opening; the rotating assembly further comprises a positioning shaft, and the positioning shaft is passed through the connecting portion and two ends of the positioning shaft are located in two ends of the support member, respectively, to connect the support member with the connecting portion.

8. The mobile phone holder according to claim 1, wherein an adhesive sticker is on the one side of the base away from the rotating disc, and the adhesive sticker is used for bonding the mobile phone.

9. The mobile phone holder according to claim 2, wherein an adhesive sticker is on the one side of the base away from the rotating disc, and the adhesive sticker is used for bonding the mobile phone.

10. The mobile phone holder according to claim 3, wherein an adhesive sticker is on the one side of the base away from the rotating disc, and the adhesive sticker is used for bonding the mobile phone.

11. The mobile phone holder according to claim 4, wherein an adhesive sticker is on the one side of the base away from the rotating disc, and the adhesive sticker is used for bonding the mobile phone.

12. The mobile phone holder according to claim 5, wherein an adhesive sticker is on the one side of the base away from the rotating disc, and the adhesive sticker is used for bonding the mobile phone.

13. The mobile phone holder according to claim 6, wherein an adhesive sticker is on the one side of the base away from the rotating disc, and the adhesive sticker is used for bonding the mobile phone.

14. The mobile phone holder according to claim 7, wherein an adhesive sticker is on the one side of the base away from the rotating disc, and the adhesive sticker is used for bonding the mobile phone.

15. The mobile phone holder according to claim 1, wherein an adhesive sticker is on the one side of the rotating disc away from the base, and the suction pad is bonded to the rotating disc through the adhesive sticker.

16. The mobile phone holder according to claim 2, wherein an adhesive sticker is on the one side of the rotating disc away from the base, and the suction pad is bonded to the rotating disc through the adhesive sticker.

17. The mobile phone holder according to claim 3, wherein an adhesive sticker is on the one side of the rotating disc away from the base, and the suction pad is bonded to the rotating disc through the adhesive sticker.

18. The mobile phone holder according to claim 4, wherein an adhesive sticker is on the one side of the rotating disc away from the base, and the suction pad is bonded to the rotating disc through the adhesive sticker.

19. The mobile phone holder according to claim 5, wherein an adhesive sticker is on the one side of the rotating disc away from the base, and the suction pad is bonded to the rotating disc through the adhesive sticker.

20. The mobile phone holder according to claim 1, wherein the suction pad comprises a base plate and a plurality of suction cups, and the plurality of suction cups are arranged on the base plate at equal intervals.
